(19) United States
(12) Patent Application Publication
(10) Pub. No.: US 2010/0243928 A1
(43) Pub. Date: Sep. 30, 2010

(54) MODULAR GAS VALVE ARRANGEMENT

(75) Inventors: Christopher Flick, Angola, IN (US); Michael Rogers, Fort Wayne, IN (US); Jih-Ching Lai, Taichung (TW)

Correspondence Address: BAKER & DANIELS LLP;111 E. WAYNE STREET, SUITE 800, FORT WAYNE, IN, 46802, US

(73) Assignee: AMERICAN FLAME, INC., Fort Wayne, IN (US)

(21) Appl. No.: 12/720,137

(22) Filed: Mar. 9, 2010

Related U.S. Application Data
(60) Provisional application No. 61/158,864, filed on Mar. 10, 2009.

(51) Int. Cl. F16K 31/00; F16K 51/00

(52) U.S. Cl. 251/61.2; 251/291

(57) ABSTRACT

A modular gas valve arrangement including a housing that has a valve chamber having a gas inlet and a gas outlet and a valve mechanism disposed in the chamber between the inlet and the outlet to control the flow of gas. An interchangeable valve control module is mounted to the housing and has a valve actuator that moves the valve mechanism to control the position of the valve mechanism to thereby control the flow of gas. A diaphragm seal is disposed between the control module and the valve mechanism to seal the valve chamber from the control module. A diaphragm seal is connected to the valve mechanism and acts to retract the valve mechanism under pressure of gas within the valve chamber.

### CROSS-REFERENCE TO RELATED APPLICATION

This application claims the benefit under Title 35, U.S.C. §119(e) of U.S. Provisional Patent Application Ser. No. 61/158,864, entitled MODULAR GAS VALVE ARRANGEMENT, filed on Mar. 10, 2009, the disclosure of which is expressly incorporated by reference herein.

### BACKGROUND

1. Field of the Invention

The present invention relates to a modular gas safety valve arrangement of the type used in natural gas and liquid propane (LP) gas fireplaces or other appliances.

2. Description of the Related Art

In a typical appliance installation, such as a gas fireplace, furnace, space heater, cooking appliance or HVAC unit, the natural gas or LP gas is delivered by means of a gas control valve having a gas supply inlet and a gas supply outlet, the latter being connected to the inlet of the main burner. The control valve supplies gas both to the main burner and to the pilot in the case of a standing pilot system. Depending on the amount of control desired by the user, such a gas control can either be an on/off valve which is controlled manually by actuating a control knob or controlled electrically by means of a solenoid or motor. The flame can also be controlled by adjusting the amount of flow through a modulating control valve by actuation of a manual control knob or a stepper motor. It is also necessary to configure the valve for either natural gas, which requires a larger orifice under low flame conditions or LP gas, which requires a smaller orifice for the same flow rate.

Presently, companies that manufacture and supply such gas control valves often must manufacture separate models of valves for the various configurations described above. This results in added tooling and manufacturing costs and higher inventory requirements.

### SUMMARY

The present invention is an arrangement whereby a common valve unit with common pilot and ignition controls can be employed in a variety of control configurations, such as solenoid on/off, manual modulation and electrical modulation and for either LP or natural gas operation. The gas valve arrangement is modified to any one of the six configurations identified above by selecting one of a manual modulating control module, a solenoid on/off control module or an electrically modulating control module employing, for example, a stepper motor. Configuring the various controls for LP or natural gas merely requires interchanging an insert adjusting the movement of a portion of the valve mechanism.

The invention greatly reduces inventory by enabling a single valve unit that includes the usual pilot and ignition controls to be supplied with one of a plurality of control modules to permit manual modulation, electrical modulation or remotely controlled solenoid on/off operation. A customer who has purchased a manually modulating modular gas valve mechanism can upgrade to an electrically modulating mechanism or on/off solenoid mechanism, both of which can be remotely controlled, merely by replacing the modular control mechanism with either a solenoid or stepper motor control mechanism. No other modifications to the overall valve mechanism are needed.

The gas valve arrangement includes a valve mechanism that is disposed in a chamber to control the flow of gas from an inlet to an outlet and further includes an interchangeable valve control module that has an actuator that controls the movement of the valve mechanism. A diaphragm seal is disposed between the control module and the valve mechanism to seal the valve chamber from the control module.

In one embodiment, the diaphragm seal is connected to the valve mechanism and gas pressure from the chamber will urge the diaphragm seal in one direction to move the valve mechanism. An actuator of the control module engages the valve mechanism through the diaphragm seal to move the valve mechanism in the opposite direction.

In one form of the invention, the modular gas valve arrangement includes a housing having a valve chamber with a gas inlet and a gas outlet and a valve mechanism disposed in the chamber between the inlet and the outlet to control the flow of gas from the inlet to the outlet. An interchangeable valve control module is mounted to the housing and has a valve actuator that moves the valve mechanism to control the position of the valve mechanism to thereby control the flow of gas from the inlet to the outlet. A seal is disposed between the control module and the valve mechanism to fluidly seal the valve chamber from the control module.

In another form of the invention, there is provided a modular gas valve arrangement that has a housing including a valve chamber with a gas inlet and a gas outlet and a valve mechanism disposed in the chamber between the inlet and the outlet to control the flow of gas from the inlet to the outlet. A valve control module is mounted to the housing and has a valve actuator that moves the valve mechanism to control the position of the valve mechanism to thereby control the flow of gas from the inlet to the outlet. A diaphragm seal member connected to the valve mechanism is disposed between the control module and the valve mechanism. One side of the diaphragm seal is exposed to gas pressure within the valve chamber to thereby move the valve mechanism under the influence of the gas pressure acting on the diaphragm seal.

### BRIEF DESCRIPTION OF THE DRAWINGS

FIG. 1 is a fragmentary perspective view showing a portion of the modular gas valve mechanism including an interchangeable manual modulating control mechanism;

FIG. 2 is a sectional view of the modular control mechanism of FIG. 1 configured for natural gas and shown in the high flow position;

FIG. 3 is a sectional view of the natural gas configured control mechanism of FIG. 2 shown in the low flow position;

FIG. 4 is a sectional view of the control mechanism of FIG. 2 configured for LP gas in the low flow position;

FIG. 5 is a sectional view of the electrically modulating modular control mechanism configured for natural gas and shown in the high flow position;

FIG. 6 is sectional view of the natural gas configured control mechanism of FIG. 5 shown in the low flow position;

FIG. 7 is a sectional view of the modular control mechanism of FIG. 5 configured for LP gas and shown in the low flow position;

FIG. 8 is a sectional view of the gas valve arrangement of FIG. 5 shown in the main burner off position; and

FIG. 9 is an enlarged perspective view of the valve body.

### DETAILED DESCRIPTION

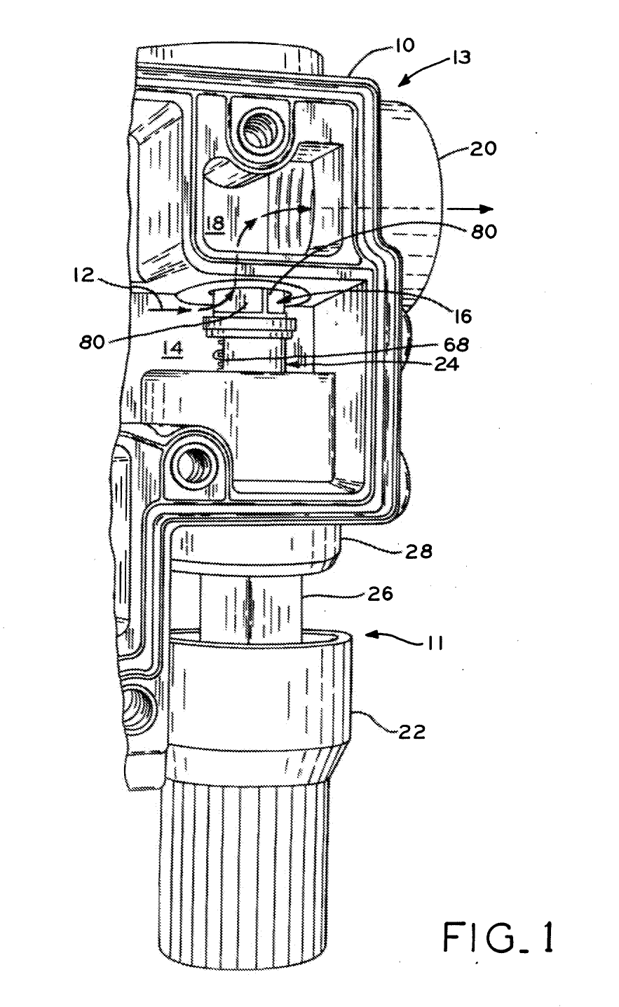

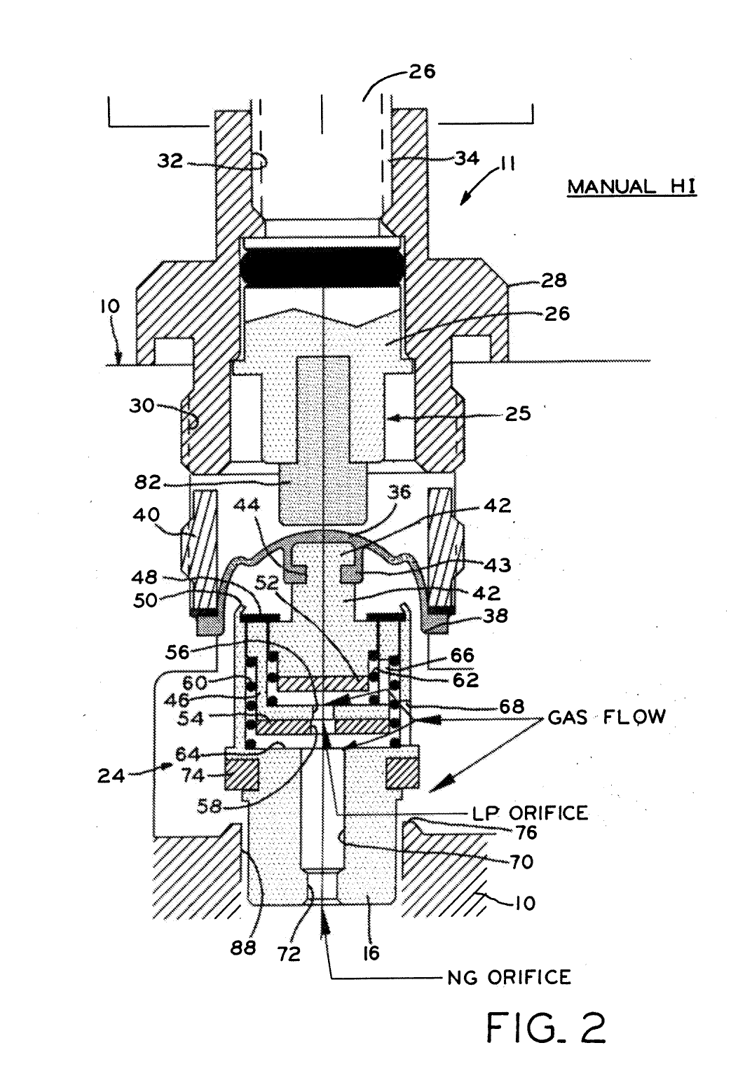

The modular gas flow arrangement in accordance with one embodiment of the present invention is a modification to the Model AF-1000 gas control valve manufactured by American Flame, Inc., doing business as Skytech Products Group and located in Fort Wayne, Ind. Said gas control valve is expressly incorporated herein by reference. Although the gas valve 13 can be used with a wide variety of gas appliances, such as furnaces, space heaters, cooking appliances and the like, it will be described in the present application in the context of a gas fireplace. Modular control mechanism 11 shown in FIGS. 2-4 is a manual modulating control module 11 for the main burner that is easily interchanged with either a solenoid on/off control module or an electrically modulating control module, as will be described hereinafter. The valve arrangement 13 includes a cast housing 10, a portion of which is illustrated in FIG. 1. Gas flow indicated by arrows 12 enters valve housing 10 through an inlet (not shown), passes through the pilot flame control portion (not shown), through valve chamber 14 around valve body 16, through chamber 18 and out outlet port 20 where it is conveyed to the fireplace main burner (not shown) through a suitable conduit (not shown). Control knob 22 is connected to the valve mechanism 24 by shaft 26 and is adapted to be rotated about its axis manually by the user to control the flow of gas from chamber 14 to outlet port 20. Threaded fitting 28 threads into an opening 30 in housing 10 (FIG. 2).

Referring now to FIG. 2, the details of valve mechanism 24 are illustrated. It will be seen that the fitting 28 includes internal threads 32 which engage the external threads 34 on shaft 26 thereby causing shaft 26 to move axially within fitting 28 when rotated.

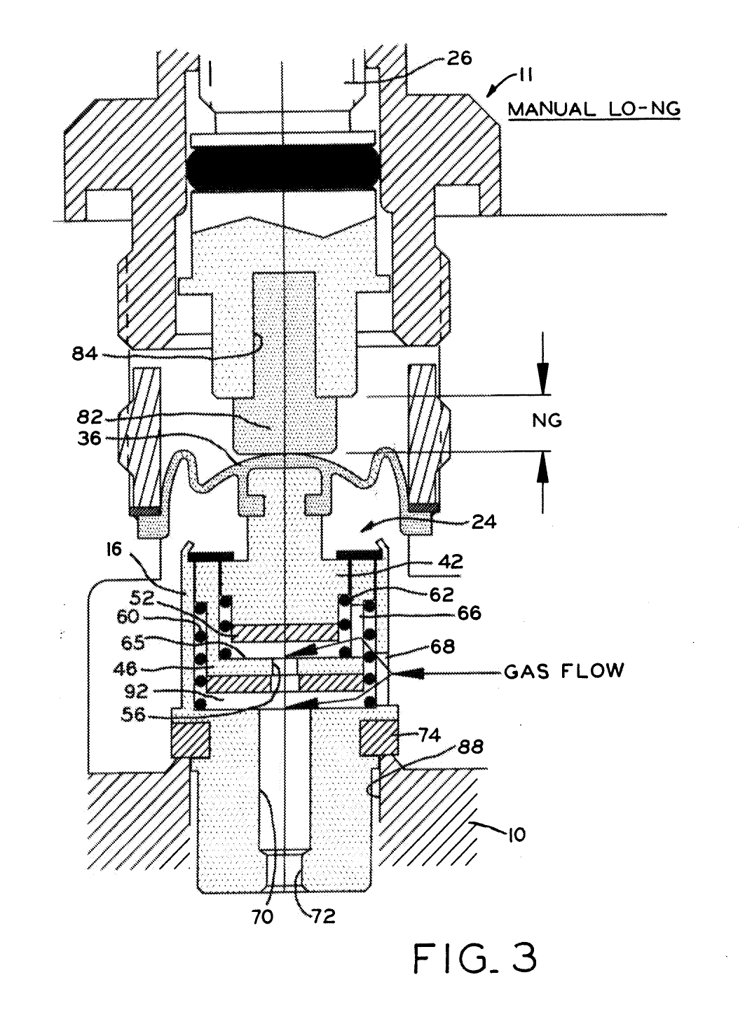

A hemispherical silicone diaphragm seal 36 is received within opening 30 and held in place against shoulder 38 by means of threaded seal retainer 40. Diaphragm seal 36 is resiliently captured on the head of shuttle 42 and includes an inwardly extending lip 43 disposed with an annular groove 44. Diaphragm seal 36 is very flexible so that it can double back on itself as shuttle 42 moves axially. Shuttle 42 nests within second shuttle 46 and both shuttles 42 and 46 are retained within valve body 16 by means of retaining ring 48 which is held in place by crimping the proximal edge 50 of valve body 16. Shuttle 42 carries circular seal 52 on its distal end and shuttle 46 carries circular seal 54 on its distal end. Shuttle 46 includes LP orifice 56 that is in alignment with orifice 58 in seal 54. Coil spring 60 is disposed between a shoulder on the proximal end of shuttle 46 and bears against surface 64 of valve body 16. Coil spring 62 is disposed between a shoulder on shuttle 42 and surface 65 (FIG. 3) of second shuttle 46. Coil spring 62 drives second shuttle 46 in the axial direction as shuttle 42 is advanced thereby compressing spring 60. Shuttle 46 includes at least one window 66 that permits gas to enter the space beneath seal 52 after it flows through at least one window 68 in valve body 16 as illustrated by the areas labeled “gas flow” in FIG. 2.

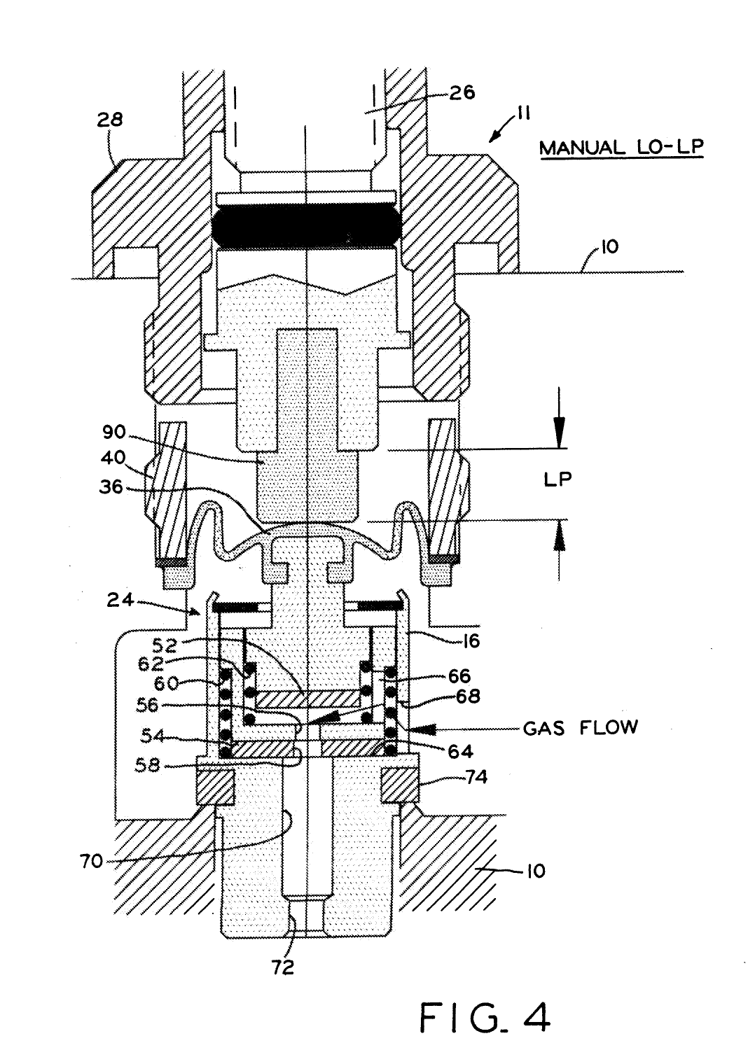

Valve body 16 includes passage 70 that is in communication with opening 66 and window 68 and extends to natural gas orifice 72. Seal 74 is pressed against shoulder 76 when the valve mechanism is advanced to the low flow positions shown in FIGS. 3 and 4.

FIG. 2 illustrates the valve mechanism in the high flow position such that gas flows around valve body 16 to outlet port 20 and through the path formed by windows 66 and 68, orifices 56 and 58, passage 70 and orifice 72. Furthermore, since valve actuator 25 formed by shaft 26 and insert 82 is in the retracted position, gas pressure within valve chamber 14 will act on the underneath side of diaphragm seal 36 to thereby move the same in an upwardly axial direction to thereby retract shuttle 42. This retracts valve body 16 to permit gas to flow between valve body 16 and the internal wall of opening 88. The high flow position permits the maximum flow of either natural gas or LP gas out of outlet port 20 to the main burner inlet, which typically includes an orifice provided by the burner manufacturer to create the proper flow for the particular design of the fireplace.

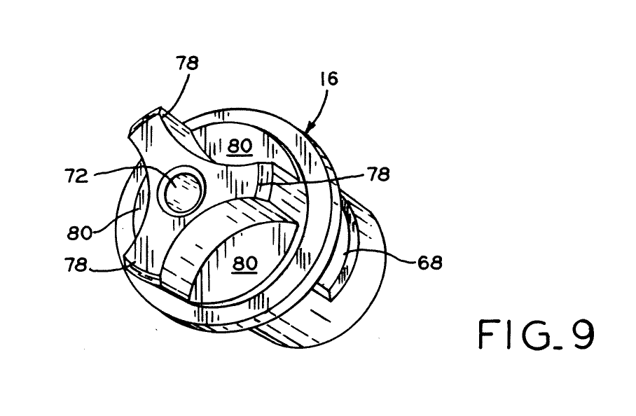

FIG. 9 illustrates an exemplary version of valve body 16 in greater detail and it will be seen that in this version the distal end comprises three arms spaced apart by 120° to form flow spaces 80 for the passage of gas around valve body 16 when in the high flow position.

FIG. 3 illustrates valve mechanism 24 in the low flow position for natural gas. Mechanism 24 includes a natural gas insert 82 removably received within bore 84 such that it can be exchanged for an LP insert 90 (FIG. 4) if the gas supply is liquid propane. As knob 22 is rotated thereby advancing threaded shaft 26, insert 82 engages diaphragm seal 36, which advances shuttle 42 thereby compressing coil spring 62 which in turn drives shuttle 46 thereby compressing spring 80 which drives valve body 16 further into bore 88 causing seal 74 to block the flow of gas around the distal end and through spaces 80 of valve body 16. This forces all of the natural gas to flow in parallel paths through orifice 56 and orifice 72, thereby providing the proper amount of low flow to the fireplace burner for natural gas.

At axial positions between the high flow position of FIG. 2 and the low flow position of FIG. 3, the cross-sectional flow area made available to the gas between flow spaces 80 (FIG. 9) and the internal wall of opening 88 will vary so that the volume of gas flowing out of outlet port 20 to the fireplace burner can be adjusted, thereby modulating the height of the flames. In the low flow position of FIG. 3, the volume of gas flow is controlled by orifice 72 and ensures that sufficient gas flows to produce a proper flame. When the control knob 22 is turned to the OFF position, seal 52 will seal against the bottom surface 65 of shuttle 46.

FIG. 4 illustrates the valve mechanism 24 in the low flow position for liquid propane. Liquid propane insert 86 which, like natural gas insert 82, is a stepped cylindrical element, has a longer portion 90 extending beyond the distal end of shaft 16 than the corresponding portion of natural gas insert 82. Thus, when in the low flow position with shaft 16 advanced as shown, seal 54 is pressed against the surface 64 of valve body 16 thereby closing off the lower flow passageway through space 92 in the natural gas low flow position illustrated in FIG. 3. Since LP gas requires lower flow than natural gas, all of the gas flow is confined to a single path formed by windows 68, 66, orifice 56, opening 58, passage 70 and orifice 72. Since the orifices and passageways are serially connected, the smallest orifice 56 controls the rate of flow.

The valve mechanism just described permits a single control module that is identical in all respects with the exception of inserts 82 and 86 to accommodate natural gas and LP gas in a manually controlled modulating control mechanism.

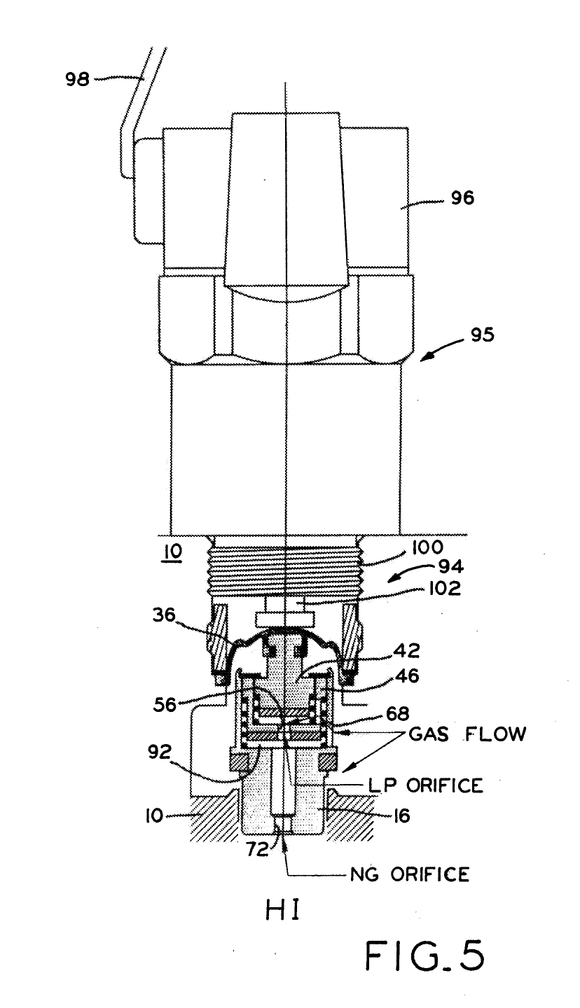

Turning now to FIGS. 5-8, a second control module 95 in the nature of an electrically modulating control module controlled by means of a conventional stepper motor 96 connected to a source of power by leads 98 is illustrated. Stepper motor 96 is threadedly secured to housing 10 through a threaded portion 100 and includes an actuating shaft 102 that is advanced axially by an internal screw mechanism (not shown) as the stepper motor rotates in a well known fashion. Since the electronic control for the stepper motor, such as any one of the wireless controls manufactured by Skytech Products Group/American Flame, Inc., can be programmed to adjust for either natural gas or LP gas operation, the utilization of interchangeable inserts 82 or 90 as in the case of the manual control of FIGS. 1-4 is not necessary. In FIG. 5, valve actuator shaft 102 of module 95 acts against the same valve mechanism 24 as in the embodiment of FIGS. 1-4 to position the mechanism 24 in the high flow position. Thus, the gas valve can be converted from a manually modulating valve to an electrically modulating valve simply by replacing control module 11 with control module 95. The valve mechanism 24 does not have to be replaced and can remain installed. Because of the presence of seal 36, the flow of gas is contained within valve chamber 14.

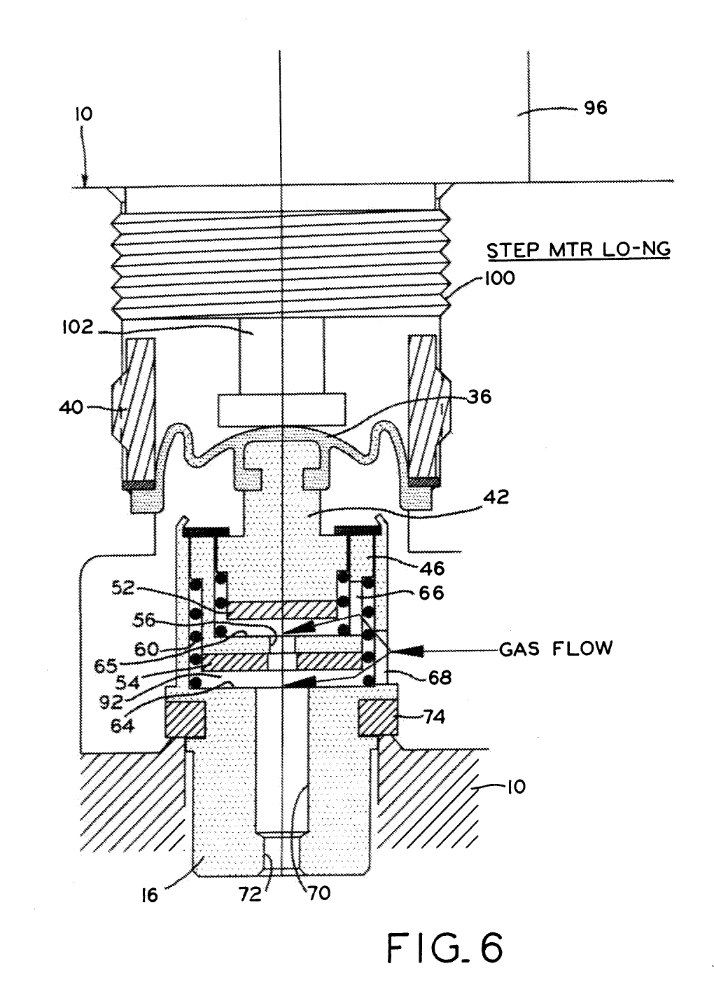

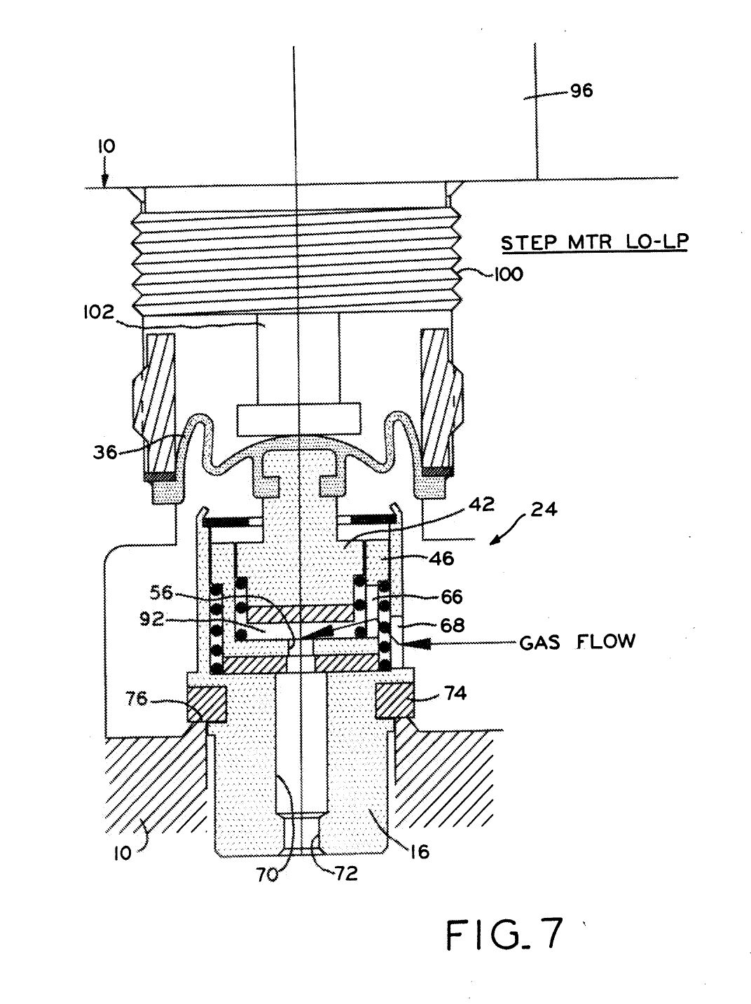

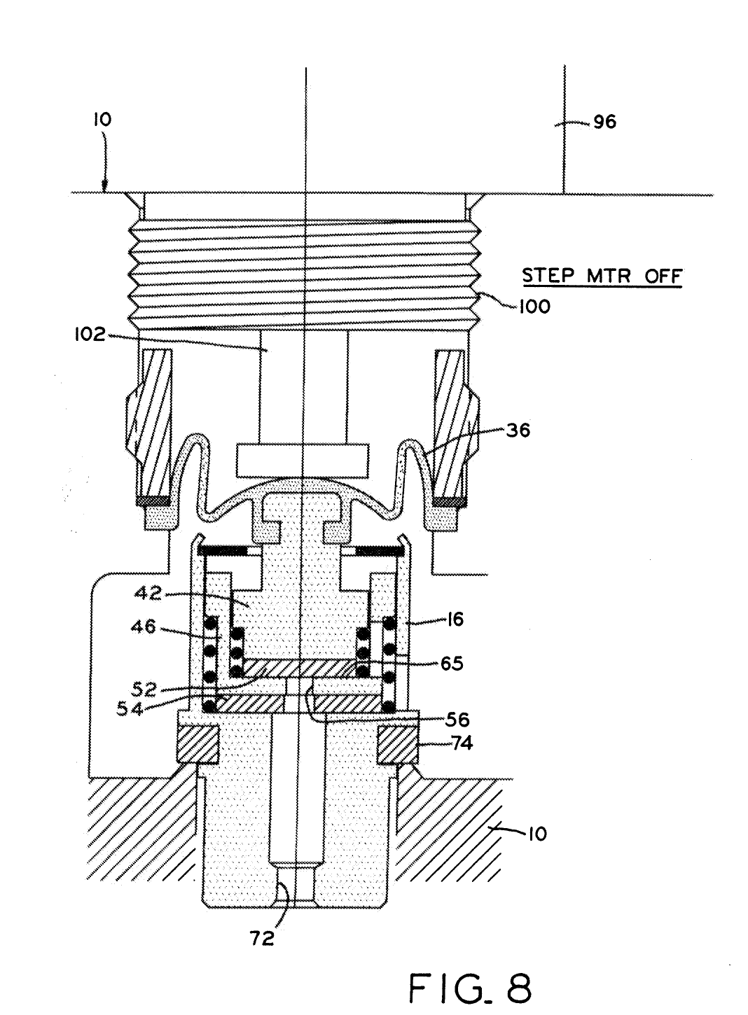

In FIG. 6, shaft 102 has advanced mechanism 24 downwardly to thereby seal valve body 16 against shoulder 76 of housing 10 to provide for the natural gas low flow condition employing the parallel flow paths as illustrated. In FIG. 7, stepper motor 96 has advanced actuating shaft 102 further so as to close off the lower flow passageway through space 92 (FIG. 6) to achieve the LP gas low flow position. In FIG. 8, motor 96 has advanced shaft 102 to the point that seal 52 bottoms against surface 65 of shuttle 46 thereby closing off all gas flow.

A third option is to replace manual module 11 or electrical modulating module 95 with a solenoid mechanism that will be substantially identical to the electrically modulating module 95 except that its actuating shaft (not shown) would have only two positions, the first being the high flow position such as that illustrated in FIG. 5 and the off position illustrated in FIG. 8. The advantage to this is that the gas flow to the main burner can be started and stopped by means of a remote control rather than having to manually rotate an on/off knob.

While the present invention has been described in the context of an exemplary embodiment, the present invention may be further modified within the spirit and scope of this disclosure. This application is therefore intended to cover any variations, uses or adaptations of the invention using its general principles. Further, this application is intended to cover such departures from the present disclosure as come within known or customary practice in the art to which this invention pertains.

What is claimed is:

1. A modular gas valve arrangement, comprising:
a housing including a valve chamber having a gas inlet and a gas outlet;
a valve mechanism disposed in said chamber between said inlet and said outlet to control the flow of gas from said inlet to said outlet;
an interchangeable valve control module mounted to said housing and having a valve actuator that moves said valve mechanism to control the position of said valve mechanism to thereby control the flow of gas from the inlet to the outlet; and
a seal disposed between said control module and said valve mechanism to fluidly seal said valve chamber from said control module.

2. The valve arrangement of claim 1, wherein said seal is disposed between said valve mechanism and the valve actuator of said control module and is contacted by said valve actuator.

3. The valve arrangement of claim 2, wherein said seal is a diaphragm acted on side thereof by gas pressure in said valve chamber and being positively connected to said valve mechanism in a manner to retract said valve mechanism when said control module valve actuator is retracted.

4. The valve arrangement of claim 3, wherein said valve mechanism includes an axially movable shuttle member that is positively connected to said diaphragm seal, said control module valve actuator includes an interchangeable insert member having a length that presets said valve to one of two discrete axial positions respectively corresponding to a higher flow natural gas setting and a lower flow LP gas setting.

5. The valve arrangement of claim 3, wherein:
said valve mechanism comprises interconnected passageways and orifices through which gas flows from the inlet to the outlet and has at least a high flow position and a low flow position, said low flow position having a low flow natural gas setting corresponding to gas flow lower than the high flow position and a low flow LP gas setting corresponding to a gas flow lower than both said high flow position and said low flow natural gas setting;
said control module valve actuator includes an interchangeable insert member having a length that engages said valve mechanism to preset said valve mechanism to one of said natural gas or LP gas settings when said valve mechanism is in its low flow position.

6. The valve arrangement of claim 2, wherein:
said valve mechanism comprises interconnected passageways and orifices through which gas flows from the inlet to the outlet and has at least a high flow position and a low flow position, said low flow position having a low flow natural gas setting corresponding to gas flow lower than the high flow position and a low flow LP gas setting corresponding to a gas flow lower than both said high flow position and said low flow natural gas setting;
said control module valve actuator includes an interchangeable insert member having a length that engages said valve mechanism to preset said valve mechanism to one of said natural gas or LP gas settings when said valve mechanism is in its low flow position.

7. The valve arrangement of claim 1, wherein:
said valve mechanism comprises interconnected passageways and orifices through which gas flows from the inlet to the outlet and has at least a high flow position and a low flow position, said low flow position having a low flow natural gas setting corresponding to a gas flow lower than the high flow position and a low flow LP gas setting corresponding to a gas flow lower than both said high flow position and said low flow natural gas setting;
said control module valve actuator includes an interchangeable insert member having a length that engages said valve mechanism to preset said valve mechanism to one of said natural gas or LP gas settings when said valve mechanism is in its low flow position.

8. The valve arrangement of claim 1, wherein said seal is a diaphragm having axial travel and is acted on one side thereof by gas pressure in said valve chamber, said seal is connected to said valve mechanism to cause said valve mechanism to move in a first axial direction in response to gas pressure in said valve chamber when said valve actuator is retracted in said first axial direction.

9. The valve arrangement of claim 8, wherein said valve mechanism comprises interconnected passageways and orifices through which gas flows from the inlet to the outlet and has at least a high flow position and a low flow position, said low flow position having a low flow natural gas setting corresponding to gas flow lower than the high flow position and a low flow LP gas setting corresponding to a gas flow lower than both said high flow position and said low flow natural gas setting.

10. The valve arrangement of claim 9, wherein said control module valve actuator includes an interchangeable insert member having a length that engages said valve mechanism to preset said valve mechanism to one of said natural gas or LP gas settings when said valve mechanism is in its low flow position.

11. The gas valve arrangement of claim 9, wherein said valve mechanism comprises an interconnected valve body, first shuttle and second shuttle having two different positions relative to each other and to said housing to achieve said low flow natural gas and LP gas settings, respectively.

12. The valve arrangement of claim 1, wherein said modular gas valve arrangement is part of a kit comprising a manually actuatable valve control module and a motor or solenoid driven valve control module, said control modules being interchangeable with each other as said valve control module mounted to said housing.

13. The valve arrangement of claim 12, wherein:
said valve mechanism comprises interconnected passageways and orifices through which gas flows from the inlet to the outlet and has at least a high flow position and a low flow position, said low flow position having a low flow natural gas setting corresponding to gas flow lower than the high flow position and a low flow LP gas setting corresponding to a gas flow lower than both said high flow position and said low flow natural gas setting;
said kit includes a natural gas insert and an LP gas insert that are interchangeable with each other in said valve control module, said natural gas and LP gas inserts, when installed in said valve control module, preset said valve mechanism to said natural gas or LP gas settings, respectively, when said valve mechanism is in its low flow position.

14. A modular gas valve arrangement, comprising:
a housing including a valve chamber having a gas inlet and a gas outlet;
a valve mechanism disposed in said chamber between said inlet and outlet to control the flow of gas from said inlet to said outlet;
a valve control module mounted to said housing and having a valve actuator that moves said valve mechanism to control the position of said valve mechanism to thereby control the flow of gas from said inlet to said outlet; and
a diaphragm seal member connected to said valve mechanism and disposed between said control module and said valve mechanism, one side of said diaphragm seal exposed to pressure within said valve chamber to thereby move said valve mechanism under the influence of the gas pressure acting on said one side of said seal.

15. The gas arrangement of claim 14, wherein said valve mechanism includes an axially movable shuttle that is connected to said diaphragm seal, and said control module includes a valve actuator that drivingly engages said shuttle of said valve mechanism to move said shuttle and thereby control the position of said valve mechanism.

16. The valve arrangement of claim 15, wherein said seal diaphragm is disposed between said valve actuator and said shuttle and is directly contacted by said valve actuator.

17. The valve arrangement of claim 16, wherein said valve actuator of said control module drives said shuttle in a first axial direction and said diaphragm seal drives said shuttle in an opposite axial direction.

18. The valve arrangement of claim 15, wherein said valve actuator of said control module drives said valve mechanism in one axial direction and said diaphragm seal drives said valve mechanism in an opposite axial direction.

19. The valve arrangement of claim 12, wherein said valve actuator of said control module drives said valve mechanism in one axial direction and said diaphragm seal drives said valve mechanism in an opposite axial direction.

20. The valve arrangement of claim 13, wherein said valve actuator of said control module drives said valve mechanism in one axial direction and said diaphragm seal drives said valve mechanism in an opposite axial direction.
